(19) United States
(12) Patent Application Publication
(10) Pub. No.: US 2011/0047178 A1
(43) Pub. Date: Feb. 24, 2011

(54) SYSTEM AND METHOD FOR SEARCHING AND QUESTION-ANSWERING

(75) Inventor: Do Gyu SONG, Seoul (KR)

Correspondence Address: LEXYOUME IP GROUP, PLLC, 5180 PARKSTONE DRIVE, SUITE 175, CHANTILLY, VA, 20151, US

(73) Assignee: Sensology Inc., Seoul (KR)

(21) Appl. No.: 12/860,988

(22) Filed: Aug. 23, 2010

(30) Foreign Application Priority Data
Aug. 24, 2009 (KR) 10-2009-0078081

(51) Int. Cl. G06F 17/30

(52) U.S. Cl. 707/769; 707/E17.014

(57) ABSTRACT

A method of searching for answers to a query in a question-answering search system based on Resource Description Framework (RDF) triples is provided. A plurality of sentences constituting texts are converted into a set of RDF triples, and a query sentence is converted into a SPARQL including query triples. Triples matching with the query triples are searched for among the set of RDF triples stored in a triple repository, sentences having those triples are arranged in order of the larger number of matching triples, and the arranged sentences are provided as a search result.

### CROSS-REFERENCE TO RELATED APPLICATION

This application claims priority to and the benefit of Korean Patent Application No. 10-2009-0078081 filed in the Korean Intellectual Property Office on Aug. 24, 2009, the entire contents of which are incorporated herein by reference.

### BACKGROUND OF THE INVENTION

(a) Field of the Invention

The present invention generally relates to a method and a system for searching and question-answering.

(b) Description of the Related Art

Search methods so far achieved are limited to a search method based on keyword pattern matching. This method depends on search based on morphological identity, in other words, keyword written in same characters.

By this search method, a large amount of search results are inevitable, and we have to check them up one by one to find exactly what we want.

This method provides a list of lots of search results including keywords, for example, to the question “who is the president of the United States?”. It provides a list of lots of documents including the keywords of the sentence “president” and “United States”, not the exact answer that we want “Barack Hussein Obama”.

Further, search methods so far achieved are configured to provide search results of surplus information, such as “bill (account)”, “bill (note)”, “bill (measure)”, “bill (certificate)”, “bill (poster)”, “bill (program)”, and “bill (table)”, for a search keyword “bill”.

Accordingly, there is a problem in that a user who searches for information cannot rapidly search for desired information because of an excessive number of search results.

### SUMMARY OF THE INVENTION

Embodiments of the present invention provide a method and an apparatus for a concrete and correct answer to a question based on the degree of identity of Resource Description Framework (RDF) triples.

An embodiment of the present invention is to provide a method of searching a query in a question-answering search system based on RDF triples. The method converts a plurality of sentences constituting texts into a set of RDF triples and converts a query sentence into a SPARQL including query triples. when the query sentence is received. The method searches for triples matching with the query triples among the set of RDF triples stored in a triple repository, arranges sentences having the matching triples in order of a sentence having the larger number of the matching triples, and provides the arranged sentences as a search result.

Searching for the triples may include checking whether there is an answer request query triple among the query triples of a SPARQL, and extracting at least one answer corresponding to a query content in a position of object of an answer request query triple of a SPARQL, when there is the answer request query triple in the query triples. The answer request query triple may be a triple having a special term including query target in a position of predicate in terms of RDF triple.

The at least one answer may be extracted by searching at least one answer in the matching triples among the triples of sentences around the sentence having the largest number of matching triples, when a triple corresponding to the answer doesn't exist among the triples of the sentence having the largest number of matching triples.

The answer request query triple may include a triple having query target in a position of predicate and concrete query content in a position of object in terms of RDF triple.

The method may modify the SPARQL by reasoning a relationship between classes and a relationship between properties in order to make the SPARQL have identical terms to the set of RDF triples stored in the triple repository.

Converting the plurality of sentences may include generating an analysis result by analyzing morphemes, generating morpheme groups, and analyzing sentence components for the plurality of sentences; generating sentence division information by dividing a sentence into blocks using the analysis result according to elements constituting the sentences; and converting the plurality of sentences into the set of RDF triples using the analysis result and the sentence division information.

According to another embodiment of the present invention, a system for searching and question-answering is provided. The system includes an RDF triple/SPARQL conversion unit, an answer processing unit, and an answer supply unit. The RDF triple/SPARQL conversion unit is configured to convert a plurality of sentences constituting texts into a set of RDF triples, and convert a query sentence into a SPARQL including query triples constituting a search condition when the query sentence is received. The answer processing unit is configured to search a set of RDF triples matching with the query triples by comparing the query triples and the set of RDF triples stored in a triple repository. The answer supply unit is configured to arrange sentences having the matching triples in order of the larger number of the matching triples, and provide the arranged sentences in order as search result.

The answer processing unit may be further configured to check whether there is an answer request query triple in the SPARQL. The answer request query triple may be a triple having query target in a position of predicate and concrete query content in a position of object in terms of RDF triple.

The answer processing unit may be further configured to extract at least one answer corresponding to a query content in a position of object of the answer request query triple of the SPARQL when there is the answer request query triple in the SPARQL.

The answer processing unit may be further configured to extract the at least one answer in the matching triples among triples of sentences around a sentence having the largest number of matching triples, when a triple corresponding to the answer doesn't exist among triples of the sentence having the largest number of matching triples.

### BRIEF DESCRIPTION OF THE DRAWINGS

FIG. 1 is a block diagram of the question-answering search system based on the degree of identity of RDF triples according to an embodiment of the present invention.

FIG. 2 is a diagram showing an example of morpheme analysis according to an embodiment of the present invention.

FIG. 3 is a diagram showing an example of morpheme group generation and sentence component analysis according to an embodiment of the present invention.

FIG. 4 is a diagram showing an example of sentence division into blocks according to an embodiment of the present invention.

FIG. 5 is a diagram showing an example of the conversion of a sentence into RDF triples according to an embodiment of the present invention.

FIG. 6 is a diagram showing an example of the conversion of a query sentence into a SPARQL according to an embodiment of the present invention.

FIG. 7 is a diagram showing a relationship between classes in the class processor according to an embodiment of the present invention.

FIG. 8 is a diagram showing an example in which a SPARQL of a query sentence is modified in order to make the SPARQL have the same terms with RDF triples stored in a triple repository according to an embodiment of the present invention.

FIG. 9 is a diagram showing an example of result and answer output provided by the answer supply unit according to an embodiment of the present invention.

FIG. 10 is a flowchart illustrating an question-answering search method based on the degree of identity of RDF triples according to an embodiment of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

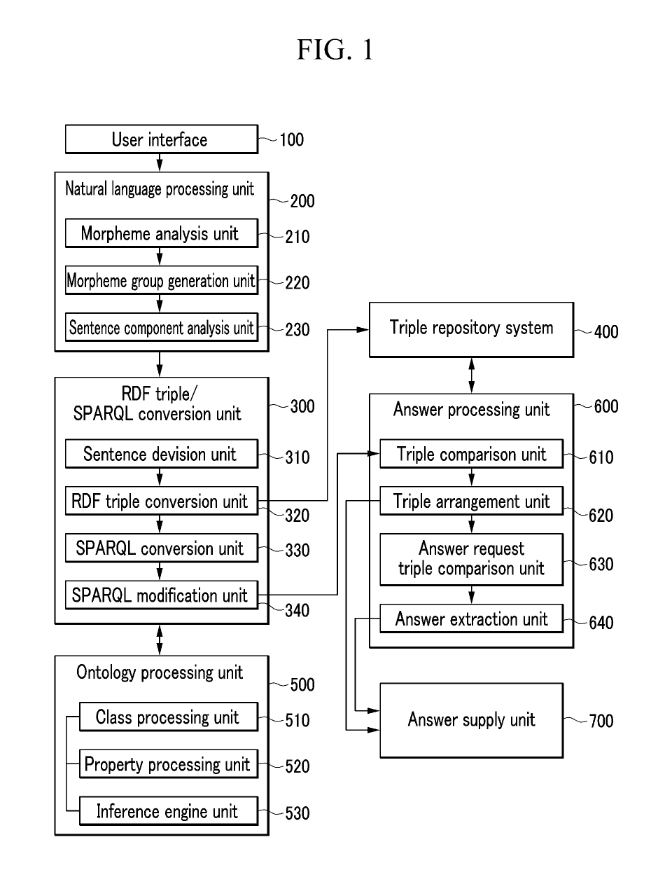

FIG. 1 is a schematic block diagram of an question-answering search system according to an embodiment of the present invention. The question-answering search system is based on the conformity of Resource Description Framework (RDF) triples.

Referring to FIG. 1, the question-answering search system includes a user interface 100, a natural language processing unit 200, an RDF triple/SPARQL conversion unit 300, a triple repository system 400, an ontology processing unit 500, an answer processing unit 600, and an answer supply unit 700.

The user interface 100 receives sentences constituting texts and query sentence inputted by a user. The user interface 100 may receive any format of information, such as a file or a web document including a lot of sentences.

The natural language processor 200 includes a morpheme analysis unit 210, a morpheme group generation unit 220, and a sentence component analysis unit 230.

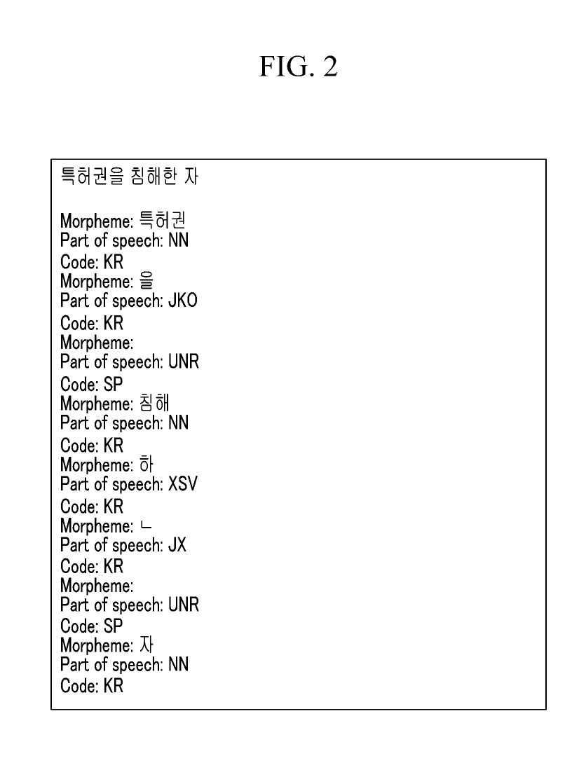

As shown in FIG. 2, the morpheme analysis unit 210 analyzes the sentences received from the user interface 100 into morphemes using electronic dictionaries. It analyzes also a part of speech and language code of each morpheme. The morpheme means the smallest unit having a meaning in natural language. In an example of FIG. 2, the sentence [symbol] [symbol] [symbol] (this is a Korean sentence having a meaning of “a person who infringes a patent right”) is divided into the morphemes of [symbol] [symbol] “ ”, [symbol] [symbol] [symbol] “ ”, and [symbol] whose parts of speech are respectively a noun (NN), an objective particle (JKO), an unregistered (UNR), a noun (NN), a suffix (XS), an auxiliary particle (JX), an unregistered (UNR), and a noun (NN). In FIG. 2, the code of “KR” means that its morpheme is Korean and the code of “SP” means a space.

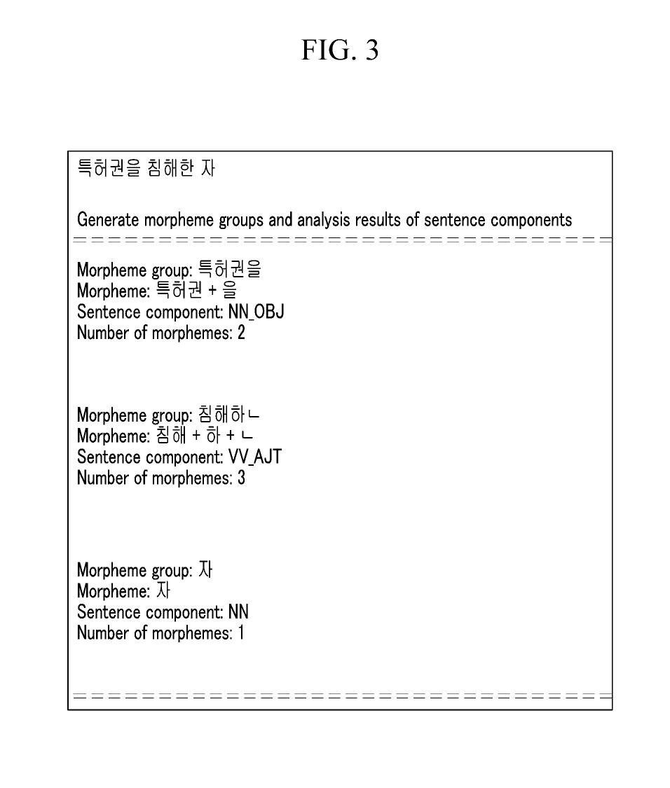

As shown in FIG. 3, the morpheme group generation unit 220 generates morpheme groups using the morphemes and information of the morphemes analyzed at the morpheme analysis unit 210. In this case, lexical and semantic features of the morphemes constituting each morpheme group, the number and grammatical information of these morphemes, and the characteristic of a part of speech for each morpheme group are analyzed. Here, the morpheme group refers to an element of sentence divided by two spaces in a correctly written Korean sentence. The morpheme groups are classified into an indeclinable morpheme group (NN), a declinable morpheme group (VV), an affirmative copular morpheme group (VNP), an adjective morpheme group (MM), an adverb morpheme group (MA), an interjection morpheme group (IC), and a conjunction morpheme group (CONJ) according to the characteristic of the part of speech. In an example of FIG. 3, the sentence [symbol] [symbol] [symbol] is divided into the morpheme groups of [symbol] [symbol] and [symbol] whose parts of speech are respectively an indeclinable morpheme group (NN), an declinable morpheme group (VV), and an indeclinable morpheme group whose element is only one (NN).

The sentence component analysis unit 230, as shown in FIG. 3, analyzes a role in sentence of morpheme groups outputted from the morpheme group generation unit 220. The sentence components are classified into a subject (SBJ), an object (OBJ), a complement (CMP), a modifier (MOD), an adjunct (AJT), a conjunctive (CNJ), and an independent (INT) according to its role in sentence. In an example of FIG. 3, the roles of [symbol] and [symbol] are respectively the object (OBJ) and the adjunct (AJT).

Referring to FIG. 1 again, the RDF triple/SPARQL conversion unit 300 includes a sentence division unit 310, an RDF triple conversion unit 320, a SPARQL conversion unit 330, and a SPARQL modification unit 340.

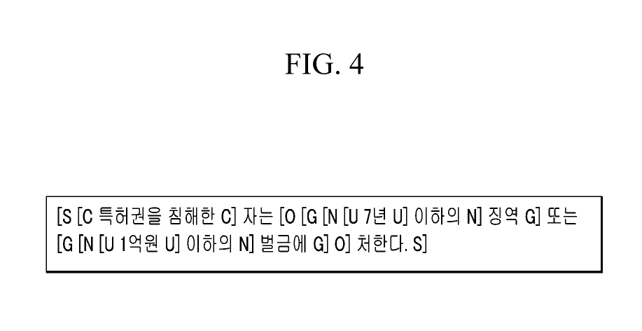

As shown in FIG. 4, the sentence division unit 310 generates sentence division information by dividing a sentence into an indeclinable word block (N), a compound noun block (N), a proper noun block (P), a unit noun block (U), a genitive block (G), a coordinate conjunction block (O), a declinable word block (V), an adnominal phrase block (C), an adverbial phrase block (B), a clause block (S), and a query block (Q) using all the results of sentence analysis received from the natural language processor 200. In an example of FIG. 4, a sentence of [symbol] [symbol] [symbol] [symbol] [symbol] [symbol] [symbol] [symbol] [symbol] [symbol] [symbol] (this sentence in Korean means “a person who infringes a patent right is subject to criminal punishment with a penal servitude of up to 7 years or by a fine of up to one hundred million Korean Won”) is a clause block (S). In this sentence, [symbol] [symbol] (who infringes a patent right)” is an adnominal phrase block (C), and the part [symbol] [symbol] [symbol] [symbol] [symbol] [symbol] [symbol] (a penal servitude of up to 7 years or by a fine of up to one hundred million Korean Won)” is a coordinate conjunction block (O). [symbol] [symbol] [symbol] (a penal servitude of up to 7 years)” and [symbol] [symbol] [symbol] (a fine of up to one hundred million Korean Won)” are genitive blocks (G), and [symbol] [symbol] (of up to 7 years)” and [symbol] [symbol] (of up to one hundred million Korean Won)” are compound noun blocks (N). Further, [symbol] (7 years)” and [symbol] (one hundred million Korean Won)” are unit noun blocks (U).

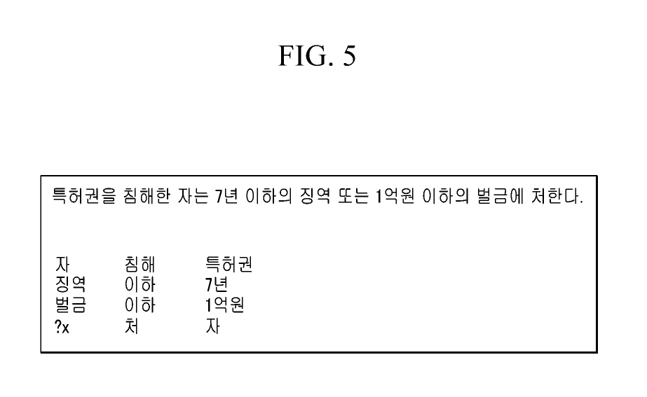

As shown in FIG. 5, the RDF triple conversion unit 320 converts natural language sentences into a set of RDF triples using all the results of the sentence analysis received from the natural language processing unit 200 and the sentence division information received from the sentence division unit 310. The RDF triple is a format in which knowledge and information are expressed in formal and standard expression using triple of subject (resource), predicate (property), and object (literal) so that the machines like computer understand the meaning of knowledge and information. RDF triple format is an international standard formal expression managed by the World Wide Web Consortium (W3C). The set of the subject (resource), the predicate (property), and the object (literal) is called a triple.

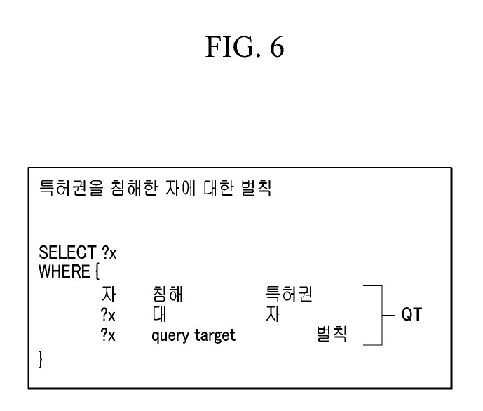

The SPARQL conversion unit 330, as shown in FIG. 6, converts a query sentence received from the user interface 100 into a SPARQL including a set of query triples QT. Here, the query triples QT refer to RDF triples constituting a portion “WHERE” in a SPARQL and define a triple search condition. The SPARQL is a query language specified for the RDF triple, and is an international standard query language managed by the W3C.

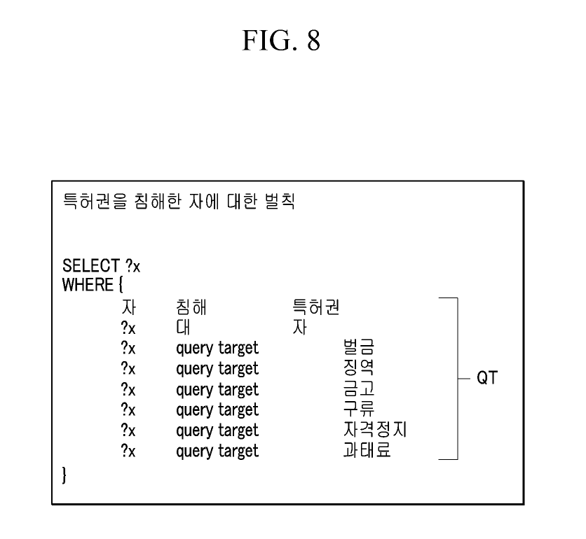

The SPARQL modification unit 340 modifies the SPARQL in order to make the SPARQL generated by the SPARQL conversion unit 330 have the same terms with RDF triples stored in the triple repository system 400 while operating in connection with the ontology processing unit 500, as shown in FIG. 8.

The triple repository system 400 stores a set of RDF triples received from the RDF triple conversion unit 320 and provides functions of deleting, updating, arranging in order, and searching for the set of RDF triples.

Referring to FIG. 1 again, the ontology processing unit 500 includes a class processing unit 510, a property processing unit 520, and an inference engine unit 530.

The class processing unit 510 processes the relationship between “rdfs:subClassOf” and “owl:equivalentClass” corresponding to classes like standard properties for classes proposed by W3C, and “superClassOf” made on the question-answering search system for treating the relationship between a class and its subordinate classes.

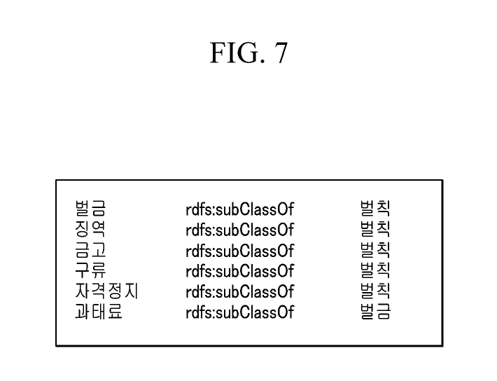

The class processing unit 510, as shown in FIG. 7, processes the hierarchical relationship and the sibling relationship of classes such as [symbol] (a fine) rdfs:subClassOf [symbol] (a penalty)” [symbol] belongs to [symbol] [symbol] (a penal servitude) rdfs:subClassOf [symbol] (a penalty)” [symbol] belongs to [symbol] [symbol] (an imprisonment) rdfs:subClassOf [symbol] (a penalty)” [symbol] belongs to [symbol] [symbol] (a confinement) rdfs:subClassOf [symbol] (a penalty)” [symbol] belongs to [symbol] [symbol] (a suspension of qualification) rdfs:subClassOf [symbol] (a penalty)” [symbol] belongs to [symbol] , and [symbol] (a penalty fee) rdfs:subClassOf [symbol] (a fine)” [symbol] belongs to

[symbol]

The class processing unit 520 processes the relationship between “rdfs:domain”, “rdfs:range”, “rdfs:subPropertyOf”, and “owl:equivalentProperty” corresponding to properties like standard properties proposed by W3C, and “superPropertyOf” made on the question-answering search system for treating the relationship between a property and its subordinate properties.

The property processing unit 520 processes the hierarchical relationship and the sibling relationship of properties, for example, [symbol] [symbol] (impose a fine) rdfs:subPropertyOf [symbol] (punish)” [symbol] [symbol] belongs to [symbol] It processes also the property ‘rdfs:domain’ which represents a relationship between property and a set of classes that can be subject in terms of RDF triple of this property, and also the property ‘rdfs:range’ which represents a relationship between property and a set of classes that can be object in terms of RDF triple of this property.

The inference engine unit 530 modifies the SPARQL through a reasoning for relationship between classes and between properties, in other words, the inference engine unit 530 applies inference rules, such as “S rdfs:subClassOf 01+01 rdfs:subClassOf 02→S rdfs:subClassOf 02”. So the inference engine unit 530 can reason [symbol] (a penalty fee) rdfs:subClassOf [symbol] (a penalty)” by applying the inference rule illustrated above to an RDF triple [symbol] (a penalty fee) rdfs:subClassOf [symbol] (a fine)” and [symbol] (a fine) rdfs:subClassOf [symbol] (a penalty)” and can extend a query triple “?x ‘query target’ [symbol] shown in FIG. 6 to “?x ‘query target’ [symbol] “?x ‘query target’ [symbol] “?x ‘query target’ [symbol] “?x ‘query target’ [symbol] “?x ‘query target’ [symbol] and “?x ‘query target’ [symbol] as shown in FIG. 8.

Referring to FIG. 1 again, the answer processing unit 600 includes a triple comparison unit 610, a triple arrangement unit 620, an answer request triple comparison unit 630, and an answer extraction unit 640.

The triple comparison unit 610 searches for matching RDF triples by comparing the query triples QT, which form search condition of a SPARQL, with the set of RDF triples stored in the triple repository system 400.

For example, as shown in the RDF triple of FIG. 5 and the SPARQL of FIG. 8, the triple comparison unit 610 searches for the sentence [symbol] [symbol] [symbol] [symbol] [symbol] [symbol] [symbol] [symbol] [symbol] [symbol] of FIG. 5 whose triple [symbol] [symbol] matches exactly with the same triple of the SPARQL of FIG. 8.

The triple arrangement unit 620 puts the sentences in order of the larger number of the matching triples between query triples QT of a SPARQL and triples stored in the triple repository system 400, receiving a comparison result from the triple comparison unit 610. The triple arrangement unit 620 determines that the semantic closeness is proportional to the number of those matching triples.

In the case in which an answer request query triple exists in a SPARQL converted from the query sentence, the answer request triple comparison unit 630 searches for concrete and corresponding answer in the matching triples between query triples QT of a SPARQL and triples stored in the triple repository system 400.

Here, the answer request query triple includes a special form, such as “query target”, in the position of predicate in terms of RDF triple of a query triple QT of a SPARQL converted from the query sentence and includes detailed query content in the position of object in terms of RDF triple.

The answer extraction unit 640 extracts answers corresponding to the query content in the position of object of answer request query triple of a SPARQL.

If a triple corresponding to the answer doesn't exist among the triples of the sentence having the largest number of matching triples, the answer extraction unit 640 extracts answers in the matching triples among the triples of the sentences around the sentence having the largest number of matching triples.

The answer supply unit 700 outputs the search result in order of the larger number of matching triples while operating in connection with the triple arrangement unit 620 and the answer extraction unit 640. If there is an answer request query triple in a SPARQL and corresponding answers, the answer supply unit 700 outputs the answers with the search result.

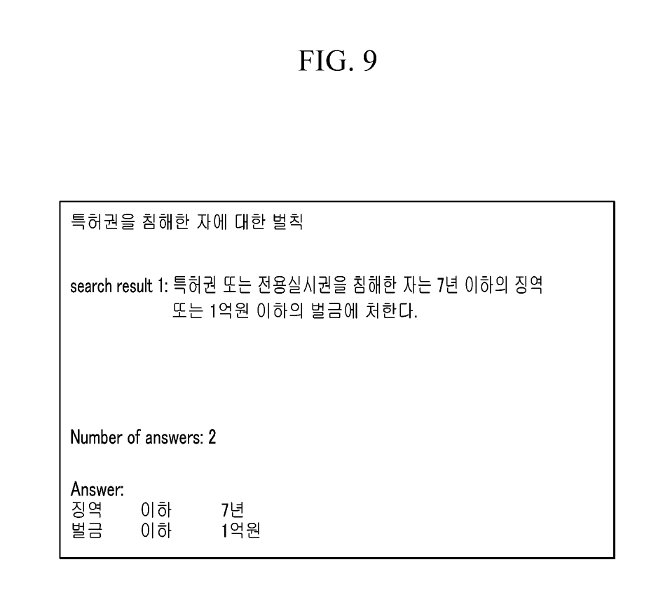

In an example of FIG. 9, the answer supply unit 700 outputs [symbol] [symbol] [symbol] [symbol] [symbol] [symbol] [symbol] [symbol] [symbol] [symbol] [symbol] [symbol] (this Korean sentence means that a person who infringes a patent right or an exclusive license is subjected to criminal punishment with a penal servitude of up to 7 years or by a fine of up to one hundred million Korean Won) as a search result to a query of [symbol] [symbol] [symbol] [symbol] [symbol] ?” (this means “what's the penalty for a person who infringes a patent right?”). In addition, the answer supply unit 700 outputs [symbol] [symbol] [symbol] (‘a penal servitude’ ‘up to’ ‘7 years’)” and [symbol] [symbol] [symbol] (‘a fine’ ‘up to’ ‘one hundred million Korean Won’)” as the answers, that are expressed themselves in the format of RDF triple.

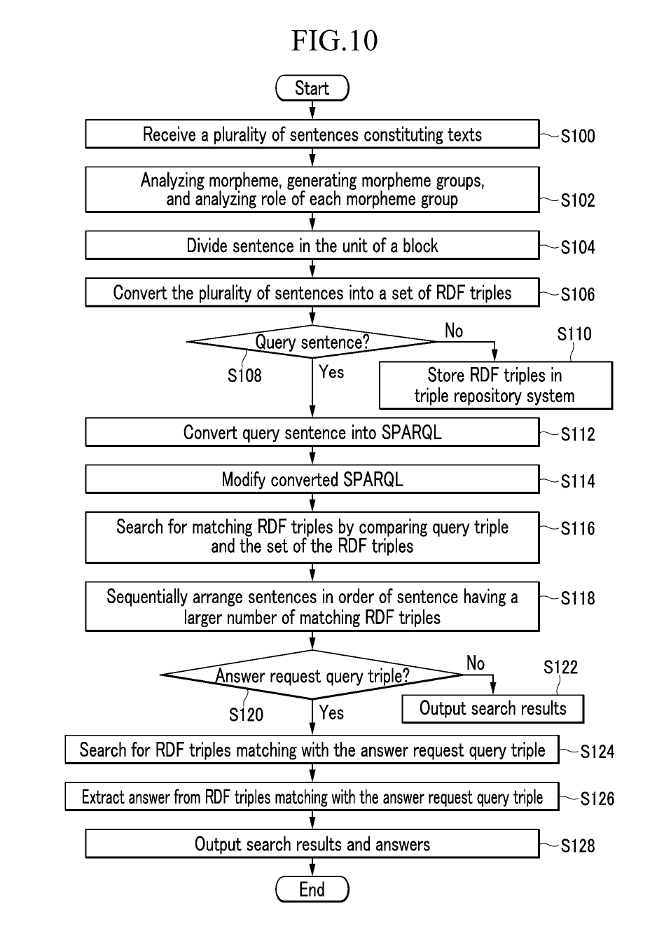

FIG. 10 is a flowchart illustrating a question-answering search method based on the degree of identity of RDF triples according to an embodiment of the present invention.

The user interface 100 receives a plurality of sentences constituting texts at step S100. The natural language processing unit 200 analyzes the sentences received from the user interface 100 into morphemes using electronic dictionaries, generates morpheme groups using the analysis result, and analyzes the role of each morpheme group in the sentence at step S102.

The sentence division unit 310 generates sentence division information by dividing a sentence into the blocks on the basis of all the results of sentence component analysis received from the natural language processing unit 200 and at step S104.

The RDF triple conversion unit 320 converts the plurality of sentences into a set of RDF triples using the analysis results of the sentence components received from the natural language processing unit 200 and the sentence division information received from the sentence division unit 310 at step S106.

It is checked whether a sentence received from the user interface 100 is a query sentence at step S108. If, as a result of checking, the sentence received from the user interface 100 is not a query sentence, the RDF triple conversion unit 320 stores a set of converted RDF triples in the triple repository system 400 at step S110.

If, as a result of checking, the sentence received from the user interface 100 is a query sentence, the SPARQL conversion unit 330 converts the received query sentence into a SPARQL composed of query triples QT at step S112.

The SPARQL modification unit 340 modifies the SPARQL through reasoning for relationship between classes and between properties in order to make the SPARQL have the same terms with the RDF triples stored in the triple repository system 400 while operating in connection with the ontology processing unit 500 at step S114.

The triple comparison unit 610 searches for matching triples by comparing the query triples QT which compose a search condition of a SPARQL with the set of RDF triples stored in the triple repository system 400 at step S116.

The triple arrangement unit 620 arranges the sentences in order of the larger number of the matching RDF triples on the basis of the number of RDF triples that have the exactly same terms of subject, predicate and object with the query triples QT and received from the triple comparison unit 610 at step S118.

The answer request triple comparison unit 630 checks whether there is a query triple whose predicate is “query target” in a SPARQL converted from the query sentence. If, as a result of checking, an RDF triple whose predicate is “query target” does not exist in the query triples QT of a SPARQL, the answer request triple comparison unit 630 sends the results retrieved at the triple arrangement unit 620 to the answer supply unit 700 at step S120. Next, the answer supply unit 700 outputs the retrieved sentences in order of the larger number of the matching RDF triples at step S122.

If, as a result of checking at step S120, an RDF triple whose predicate is “query target” exists in the query triples QT of a SPARQL converted from the query sentence, the answer request triple comparison unit 630 searches, first of all, matching triples among the set of RDF triples of the sentence having the largest number of matching triples stored in the triple repository at step S124.

The answer extraction unit 640 searches the RDF triple matching with the answer request query triple of a SPARQL among the triples of the sentence having the largest number of matching triples and extracts the answers which are placed in the position of object in terms of RDF triple in the matching triple and sends these extracted answers to the answer supply unit 700 at step S126.

The answer supply unit 700 outputs the search result in order of the larger number of matching RDF triples. If there are concrete answers, the answer supply unit 700 outputs the answers together with the search result at step S128.

As described above, according to the embodiment of the present invention, the question-answering search system based on the semantic processing that converts a plurality of sentences constituting texts and a query sentence into RDF triple is provided. Further, there is an advantage in that intelligent meaning-based knowledge information processing that can understand and process the meaning of knowledge and information is possible. In addition, since meaning-based knowledge and information processing is possible, a concrete and correct answer can be provided and so intelligent knowledge and information search becomes possible.

The embodiments of the present invention are not only implemented through the method and apparatus, but may be implemented through a program for realizing a function corresponding to a construction according to an embodiment of the present invention or a recording medium on which the program is recorded.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method of searching for an answer to a query in a question-answering search system based on Resource Description Framework (RDF) triples, the method comprising:
converting a plurality of sentences constituting texts into a set of RDF triples;
converting a query sentence into a SPARQL including query triples when the query sentence is received;
searching for triples matching with the query triples among the set of RDF triples stored in a triple repository;
arranging sentences having the matching triples in order of a sentence having a larger number of the matching triples; and
providing the arranged sentences as a search result.

2. The method of claim 1, wherein searching for the triples comprises:
checking whether there is an answer request query triple among the query triples of a SPARQL, the answer request query triple being a triple having a special term including query target in a position of predicate in terms of RDF triple; and
extracting at least one answer corresponding to a query content in a position of object of an answer request query triple of a SPARQL, when there is the answer request query triple in the query triples.

3. The method of claim 2, wherein the at least one answer is extracted by searching at least one answer in the matching triples among triples of sentences around sentence having the largest number of matching triples, when a triple corresponding to the answer doesn't exist among triples of the sentence having the largest number of matching triples.

4. The method of claim 2, wherein the answer request query triple comprises a triple having query target in a position of predicate and concrete query content in a position of object in terms of RDF triple.

5. The method of claim 1, further comprising modifying the SPARQL by reasoning a relationship between classes and a relationship between properties in order to make the SPARQL have identical terms to the set of RDF triples stored in the triple repository.

6. The method of claim 1, wherein converting the plurality of sentences comprises:
generating an analysis result by analyzing morphemes, generating morpheme groups, and analyzing sentence components for the plurality of sentences;
generating sentence division information by dividing a sentence into blocks using the analysis result according to elements constituting the sentences; and
converting the plurality of sentences into the set of RDF triples using the analysis result and the sentence division information.

7. A system for searching for an answer to a query, the system comprising:
an RDF triple/SPARQL conversion unit configured to convert a plurality of sentences constituting texts into a set of RDF triples, and convert a query sentence into a SPARQL including query triples constituting a search condition when the query sentence is received;
an answer processing unit configured to search a set of RDF triples matching with the query triples by comparing the query triples and the set of RDF triples stored in a triple repository; and
an answer supply unit configured to arrange sentences the matching triples in order of the larger number of the matching triples, and provide the arranged sentences in order as search result.

8. The system of claim 7, wherein the answer processing unit is further configured to check whether there is an answer request query triple in the SPARQL, an answer request query triple being a triple having query target in a position of predicate and concrete query content in a position of object in terms of RDF triple.

9. The system of claim 7, wherein the answer processing unit is further configured to extract at least one answer corresponding to a query content in a position of object of the answer request query triple of the SPARQL, when there is the answer request query triple in the SPARQL.

10. The system of claim 9, wherein the answer processing unit is further configured to extract the at least one answer in the matching triples among triples of sentences around a sentence having the largest number of matching triples, when a triple corresponding to the answer doesn't exist among the triples of the sentence having the largest number of matching triples.
